(19) United States
(12) Patent Application Publication
(10) Pub. No.: US 2002/0154338 A1
(43) Pub. Date: Oct. 24, 2002

(54) Method, system and program for print order in a composite-image printing service

(76) Inventor: Keisuke Tanaka, Kaisei-machi (JP)

Correspondence Address: BIRCH STEWART KOLASCH & BIRCH, PO BOX 747, FALLS CHURCH, VA, 22040-0747, US

(21) Appl. No.: 10/108,869

(22) Filed: Mar. 29, 2002

(30) Foreign Application Priority Data
Mar. 29, 2001 (JP) 096167/2001

(51) Int. Cl. B41J 1/00; G06F 15/00

(52) U.S. Cl. 358/1.18; 358/1.15

(57) ABSTRACT

A user can easily select a template data set at the time of ordering picture postcards generated from the template data set and image data. The user connects a user terminal to a print order reception center via a network and uploads the image data to be printed. An order reception server displays composite images generated by inserting the image data in an image insertion area of each of template data sets. The user selects one of the template data sets as desired, and adjusts a position and an enlargement ratio of the image data to generate a postcard data set. A quantity and an agency at which the picture postcards are to be received are also designated. The print order reception center prints the postcards and delivers the postcards to the agency designated by the user.

### BACKGROUND OF THE INVENTION

1. Field of the Invention

The present invention relates to a print order method and a print order system for receiving a print order regarding image data via a network. The present invention also relates to a program that causes a computer to execute the print order method.

2. Description of the Related Art

There have been known digital photograph service systems for carrying out various kinds of digital photograph services such as storing photographs obtained by users in image servers after digitization thereof, recording the photographs in CD-Rs to be provided to the users, printing images photographed by users with digital cameras, and receiving orders for additional prints. As one form of such digital photograph service systems, a network photograph service system for receiving print orders via a network such as the Internet has also been proposed.

In such a network photograph service system, a user installs viewer software in his/her personal computer, which acts as a user terminal, for reproducing image data recorded in a CD-R or obtained by a digital camera. The user reproduces images represented by the image data, and generates order information describing the content of an order by using an ordering function built-in to the viewer software if the user wishes to place an order. The user transfers the order information and the image data to be printed from the user terminal to an order reception server via the network such as the Internet.

The order reception server transfers the order information and the image data to a printer server installed in a laboratory or in a mini-laboratory of a DPE store. The printer server prints the image data based on the order information, and generates an additional print, a picture postcard comprising a template and a photograph inserted in the template, or a photograph album. In the case where the order reception server and the printer server are located at the same place, printing is carried out immediately after reception of the image data and the order information.

The printed matter generated in the above manner is delivered to an agency specified by the user at the time of placing the order. In this manner, the user can receive the printed matter by paying a charge at the agency.

The order information herein referred to is information such as a processing number for specifying the content of a printing service (generation of additional prints or picture postcards or the like), an image number for specifying a photograph, a print size, a quantity of prints, specification of printing paper (such as glossy or non-glossy), thickness of the printing paper, the content of photographic processing, and trimming specification, for example. The order information may further include information regarding the name, the address, the zip code and the phone number of the user, for example.

In the case where an order for a picture postcard is placed in the network photograph service system described above, a photograph used for composite image generation is prepared and a template used for composition with the photograph is selected from a selection screen in which templates for picture postcards are displayed. Each of the templates for picture postcards has an area in which a photograph can be inserted. At the time of template selection, the insertion area is displayed in black. After selection of the template used for composition, a position and an enlargement ratio or the like are specified for inserting the photograph in the insertion area in the template. In the service described above, personal information such as the name, the address, and an E-mail address of the user can also be input and inserted in the picture postcard. After the procedure described above has been carried out, a print image of the picture postcard is displayed and the user can place the order for the picture postcard if he/she is satisfied with the print image.

However, in the print order method described above, understanding how the print image looks is difficult before composition of the template with the photograph is carried out. In the case where the print image is not satisfactory, the user needs to select another template, which is troublesome for the user.

### SUMMARY OF THE INVENTION

The present invention has been conceived based on consideration of the above circumstances. An object of the present invention is therefore to provide a print order method, a print order system and a program that enable a user to easily understand how a print image looks at the time of selecting a template used for composite image generation.

A print order method of the present invention is a method used in a printing service for printing a picture postcard by generating a composite image according to specification input by a user. The composite image is generated from image data owned by the user and a template data set selected by the user from a plurality of postcard template data sets prepared in advance. The print order method comprises the steps of:

displaying a plurality of print images generated by composition of the image data with the respective postcard template data sets; and

enabling the user to select the template data set by confirming how the composite image looks by using the displayed print images.

A print order system of the present invention comprises:

an order reception server for receiving a print order for a picture postcard generated by composition of image data owned by a user with a template data set selected by the user from a plurality of postcard template data sets prepared in advance; and

a user terminal connected to the order reception server via a network and used by the user for placing the print order. The print order system is characterized by that the order reception server has a program installed therein to cause the order reception server to execute the procedures of;

displaying on the user terminal a plurality of print images generated by composition of the image data with the respective postcard template data sets; and

enabling the user to select the template data set based on the displayed print images.

Displaying the print images refers to displaying all the print images in the same screen at the same time or gradually displaying the print images (one by one or every two images, for example). In other words, any display method can be adopted as long as the user can understand how composite images generated from the image data and the respective postcard template data sets look and can select the template data set as desired. Furthermore, not all the print images are necessarily displayed. In other words, the display can be stopped at the time the user finds a print image to his/her liking.

The order reception server is a server computer installed in a print order reception center or the like dedicated to print order reception. The order reception server is connected directly to a printer if the print order reception center has the printer. In the case where the print order reception center is not equipped with a printer, the order reception server is connected via the network to a printer server installed in a large-scale laboratory or in a mini-laboratory of a DPE store. The DPE store can act as an agency.

In the case where the order reception server is connected directly to the printer, the picture postcard can be printed immediately after reception of the print order. Meanwhile, if the order reception server is connected to the printer server via the network, the order reception server transfers the image data and agency information to the printer server after reception of the print order, and the printer server carries out the printing.

In the print order system of the present invention, it is preferable for the order reception server to carry out the composition of the image data with the template data set, based on composition information input by the user for defining an area of an image represented by the image data to be inserted in an image data insertion area of the template data set.

The order reception server may further carry out composition of personal information of the user such as the name and the address input by the user with the template data set. Furthermore, the order reception server may store the personal information to be used for the composition of the personal information with the template data set. Moreover, the order reception server may store the content of the print order for the picture postcard placed by the user so that the printing can be carried out again based on the stored content of the print order.

The order reception server may receive a narrowing condition for narrowing the postcard template data sets from an external Web server connected thereto via the network so that only the postcard template data sets agreeing with the narrowing condition among the postcard template data sets can be displayed for the user as candidates for the template data set used for generation of the picture postcard.

A program that causes a computer such as the order reception server to execute a print order method of the present invention comprises the procedures of:

receiving a print order; and

displaying a plurality of print images generated by composition of image data with a plurality of template data sets.

According to the present invention, the print images generated from the image data and the postcard template data sets are displayed at the time of selecting the desired template data set. Therefore, the user can visually understand how the picture postcard looks at the time of selecting the template data set, and the user can easily select the desired template data set.

### BRIEF DESCRIPTION OF THE DRAWINGS

FIG. 1 is a block diagram showing a configuration of a network photograph service system adopting a print order system of a first embodiment of the present invention;

FIG. 2 is a flow chart showing a procedure carried out in the first embodiment;

FIG. 3 is a flow chart showing when each of screens is displayed in the network photograph service system;

FIG. 4 shows a network new-year card Web screen;

FIG. 5 shows an image uploading Web screen;

FIG. 6 shows an image1 orientation/center setting Web screen;

FIG. 7 shows a sender information input Web screen;

FIG. 8 shows a template selection (step 1) Web screen;

FIG. 9 shows a template selection (step 2) Web screen;

FIG. 10 shows a template selection (step 3) Web screen;

FIG. 11 shows a finish confirmation Web screen;

FIG. 12 shows a customization Web screen;

FIG. 13 shows a favorites Web screen;

FIG. 14 is a block diagram showing a configuration of a network photograph service system adopting a print order system of a second embodiment of the present invention; and

FIG. 15 shows a Web address of an order reception server used in the second embodiment.

### DESCRIPTION OF THE PREFERRED EMBODIMENTS

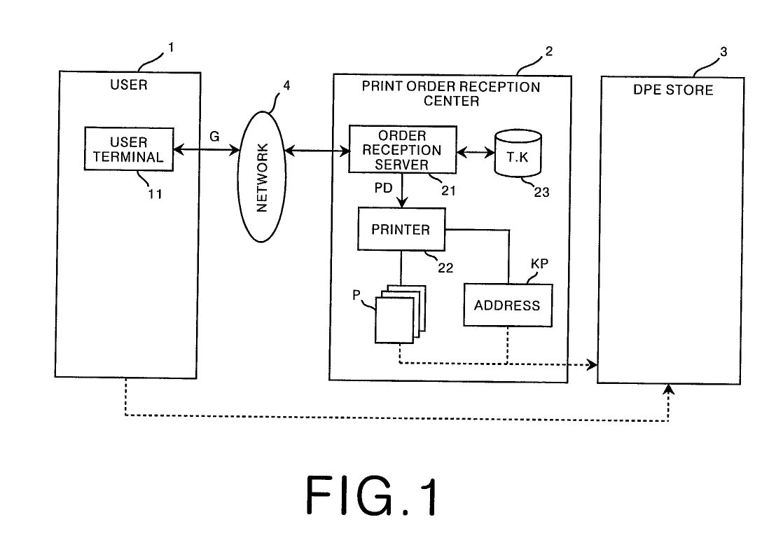

Hereinafter, embodiments of the present invention will be explained with reference to the accompanying drawings. FIG. 1 is a block diagram showing a configuration of a network photograph service system adopting a print order system of a first embodiment of the present invention. In the network photograph service system shown in FIG. 1, data, prints and the like are exchanged between a user 1, a print order reception center 2, and a DPE store 3.

The user 1 has a user terminal 11 such as a personal computer, and can place a print order for a picture postcard or picture postcards P (hereinafter referred to as the postcards P) with the print order reception center 2 via a network 4. In the case where the user 1 does not have a personal computer, the user 1 can use an order terminal installed in a service station or the like as the user terminal 11.

The print order reception center 2 has an order reception server 21 for print order reception, a printer 22 for obtaining the postcards P from a postcard data set PD generated by composition of image data G transferred from the user terminal 11 via the network 4 at the time of placing the print order with template data sets T, and a database 23 for storing the template data sets T and agency address information K and the like. The printer 22 generates a label KP by printing the address of an agency based on the agency address information K. In this manner, the print order reception center 2 delivers the postcards P to the agency address (to the DPE store 3 in this embodiment) by pasting the label KP on a bag containing the postcards P, for example.

The user 1 can transfer the image data G from the user terminal 11, carry out composition of the image data G with the template data sets T, confirm the postcard data set PD, and place the print order by using the user terminal 11. At the time of placing the print order, the user terminal 11 accesses the order reception server 21 in the print order reception center 2 by using a function of Web browser software installed in the user terminal 11. Based on information such as an html file or Java Script stored in the order reception server 21, an order Web screen is displayed on the user terminal 11. The print order is placed via the order Web screen.

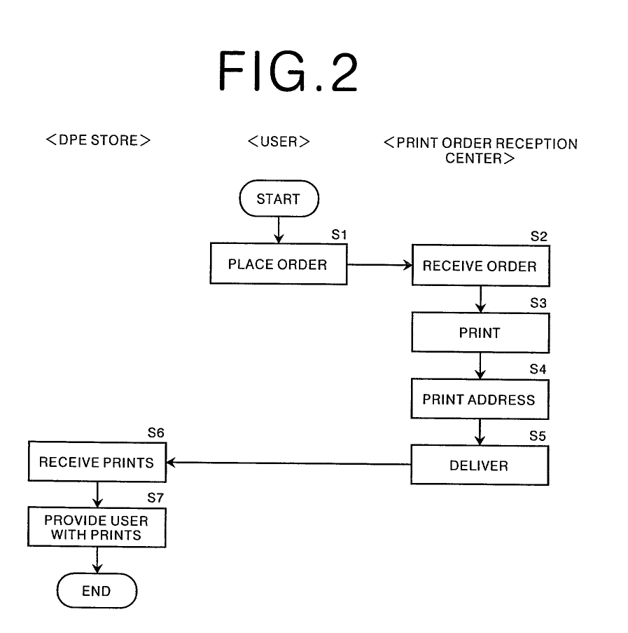

Operation of the first embodiment will be explained next. FIG. 2 is a flow chart showing a procedure carried out in the first embodiment.

The user 1 transfers the image data G used for the postcards, and places the print order for printing the postcard data set PD generated by using the image data G and the template data sets T (Step S1). The print order is transferred to the order reception server 21 in the print order reception center 2, and the order is received (Step S2). Hereinafter, the procedure at Step S1 and Step S2 will be explained in detail.

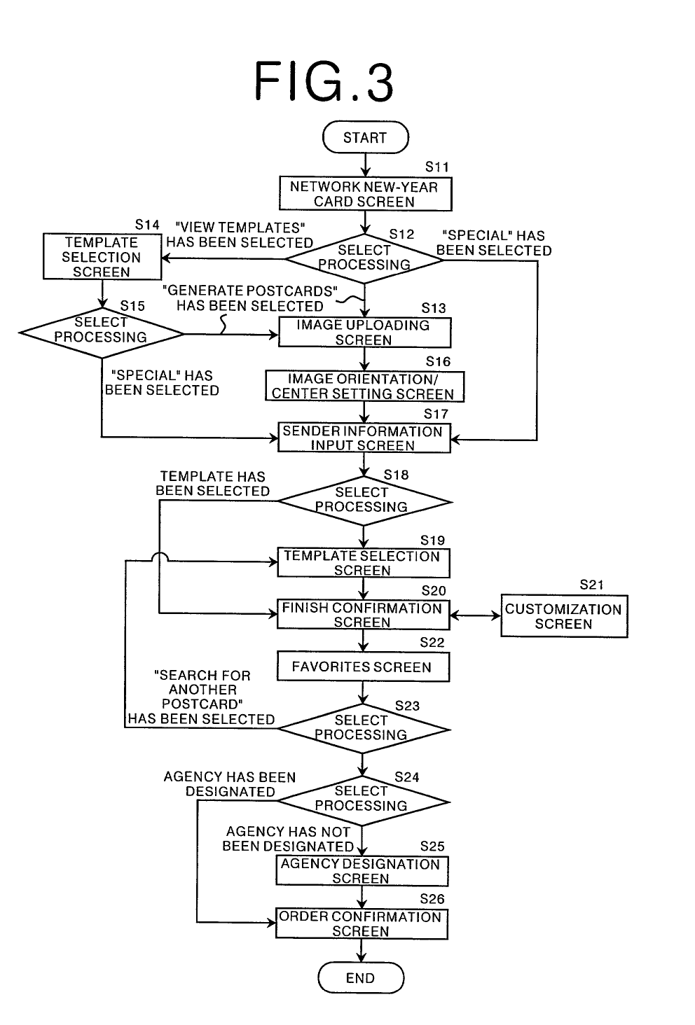

FIG. 3 is a flow chart showing when each screen is displayed in the network photograph service system. The user terminal 11 is connected to the order reception server 21 in the print order reception center 2 via the network 4, by the function of the Web browser software installed in the user terminal 11. The order Web screen for placing the print order is displayed on the user terminal 11, based on the information stored in the order reception server 21. The user 1 inputs information necessary for placing the print order, such as a user ID and a password, in the Web screen. The user terminal 11 is then connected to the order reception server 21.

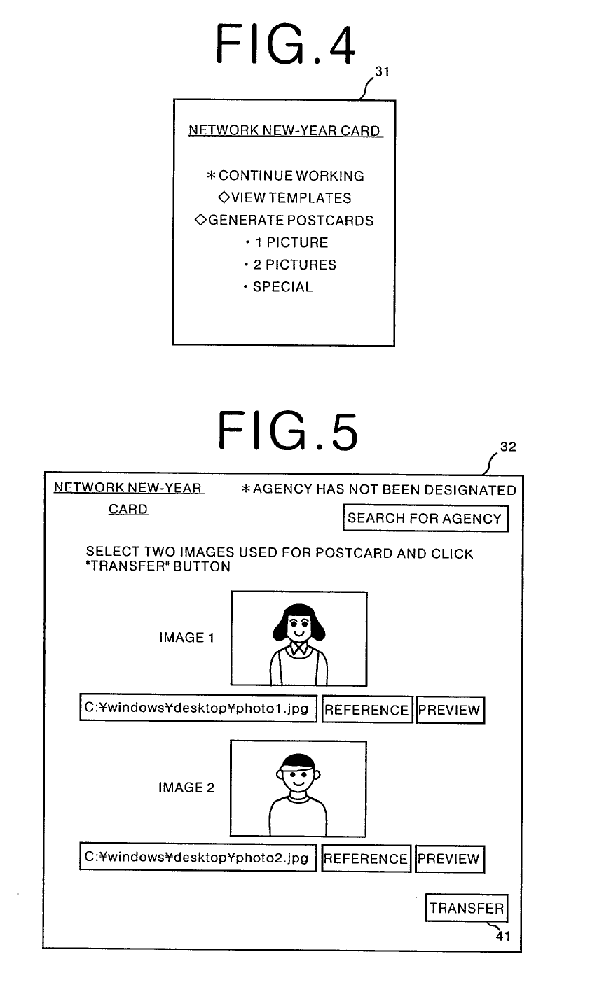

After connection to the order reception server 21 is established, a network new-year card Web screen 31 is displayed on the user terminal 11 (Step S11), as shown in FIG. 4. The user 1 can select any desired item from a menu displayed in the network new-year card Web screen 31 (Step S12). The menu is largely divided into “Continue Working”, “View Templates” and “Generate Postcards”. By selecting “Continue Working”, a user can continue an uncompleted postcard generation process, terminated during a previous access to the server or the like. In “Generate Postcards”, “1 picture”, “2 pictures”, and “Special” are selectable. The items “1 picture” and “2 pictures” refer to using 1 picture or 2 pictures for picture postcard generation, and “Special” refers to generation of postcards without a picture.

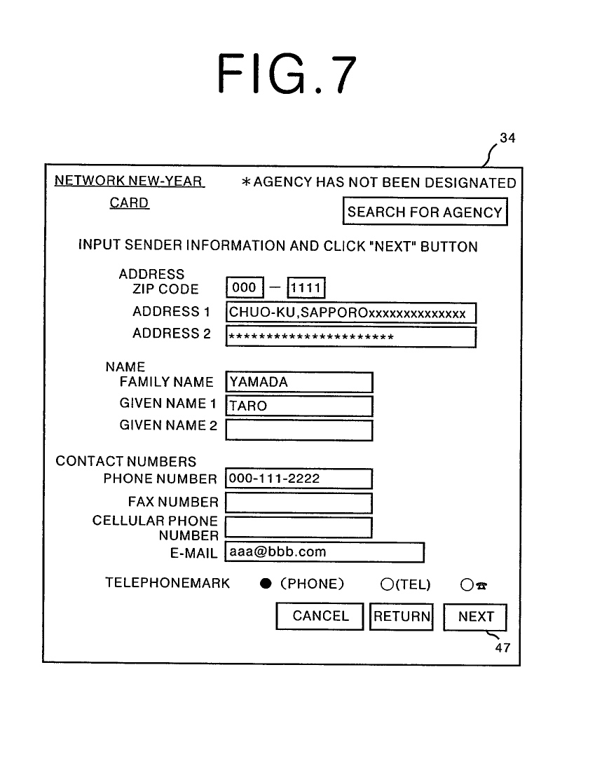

When the user 1 selects “View Templates”, a template selection Web screen (not shown) is displayed (Step S14). The template data sets stored in the database 23 are displayed by being classified in categories, and all the template data sets for “1 picture”, “2 pictures” and “Special” are selectable. When the user 1 selects one of the template data sets for “1 picture” or “2 pictures” in the template selection Web screen, an image uploading Web screen 32 is displayed (Step S13), as shown in FIG. 5. In the case where the user has selected one of the template data sets for “Special”, a sender information input Web screen 34 is displayed (Step S17), as shown in FIG. 7.

In the case where the user 1 has selected “1 picture” or “2 pictures” in “Generate Postcards” in the network new-year card Web screen 31, the image uploading Web screen 32 shown in FIG. 5 is displayed (Step S13). In the case where the user 1 has selected “Special” in “Generate Postcards” in the Web screen 31, the sender information input Web screen 34 shown in FIG. 7 is displayed (Step S17).

In this embodiment, the user 1 is assumed to have selected “2 pictures” in the network new-year card Web screen 31.

Each of the Web screens shown from Step S13 to Step S22 has a “Search for Agency” button. The user 1 can designate an agency at which the user receives the postcards P in any one of the Web screens in the above steps. The order reception server 21 displays an agency designation Web screen that will be explained later, when the user 1 clicks the “Search for Agency” button. The order reception server 21 enables the user to designate the agency. After the agency has been designated, the order reception server 21 displays the Web screen used immediately before designation of the agency.

When the user 1 selects “2 pictures” from the menu in the network new-year card Web screen 31, the order reception server 21 displays the image uploading Web screen 32 on the user terminal 11 (Step S13), as shown in FIG. 5. In the image uploading Web screen 32, images represented by paths designated by the user 1 are previewed. The user 1 confirms the images in the preview, and clicks a “Transfer” button 41 if the user 1 agrees to the images. After the Transfer button 41 has been clicked, the image data G are transferred from the user terminal 11 to the order reception server 21. In this embodiment, two image data sets G1 and G2 are transferred as the image data G, since “2 pictures” has been selected in the network new-year card Web screen 31.

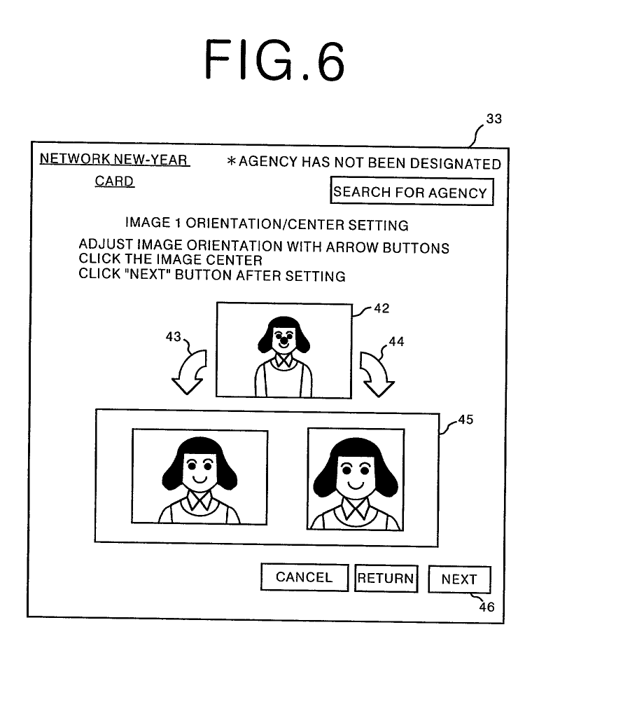

The order reception server 21 receives the image data sets and displays an image1 orientation/center setting Web screen 33 (Step S16), as shown in FIG. 6. The image represented by the image data set G1 transferred by the user 1 via the image uploading Web screen 32 is displayed in an image display area 42 in the image1 orientation/center setting Web screen 33. If the user 1 clicks an arrow icon 43 or an arrow icon 44 in the image display area 42, the image represented by the image data set G1 is rotated by 90° toward the orientation shown by the arrow icon that has been clicked. The user 1 designates the center of the image to be inserted in an image data insertion area of each of the template data sets T, by clicking the center with a mouse. Once the orientation and the center have been specified, a trimmed image generated by trimming the image in a portrait-orientation area set in advance and a trimmed image generated by trimming the image in a landscape-orientation area set in advance are shown, with the center of the trimmed images located at the center designated by the user.

The image is trimmed by using an enlargement ratio of the image data set G1. However, in the case where the area for trimming in the portrait orientation or in the landscape orientation is larger than the area of the image represented by the image data set G1, the enlargement ratio is increased to fully display the trimmed image in the area.

In the image1 orientation/center setting Web screen 33, the trimmed images are temporarily designated for later displaying print images generated by composition with all the template data sets T. Therefore, the enlargement ratio is set to 1 or adjusted automatically. However, as will be explained later, the user 1 can adjust the enlargement ratio for composition in a customization Web screen 39.

The trimmed images in the portrait-orientation area and in the landscape-orientation area are shown in a trimmed image display area 45. Since the trimmed images are represented by only a portion of the image data set G1, the trimmed images are displayed after being enlarged appropriately so that the user can easily understand how the trimmed images look.

The user 1 confirms the trimmed images and clicks a “Next” button 46 if the trimming result is satisfactory.

After the user 1 clicks the “Next” button 46, an image2 orientation/center setting Web screen is displayed, since “2 pictures” has been selected in the network new-year card Web screen 31. In the case where “1 picture” has been selected in the Web screen 31, the sender information input Web screen 34 is displayed.

The image2 orientation/center setting Web screen is the same as the image1 orientation/center setting Web screen 33. The user 1 sets the orientation and the center for the image data set G2, and confirms trimmed images displayed in a trimmed image display area. If the trimming result is satisfactory, the user 1 clicks a “Next” button.

The order reception server 21 displays the sender information input Web screen 34 shown in FIG. 7 (Step S17), when the user 1 clicks the “Next” button in the image2 orientation/center setting Web screen. Input areas for sender information such as the name, the address, and contact numbers of the user 1 are shown in the Web screen 34. A telephone mark selection area is also shown in the Web screen 34. In the case where the user 1 uses this network photograph service for the first time, the address of the user 1 input by the user at the time of user registration is shown in the input areas as default information.

The user 1 inputs the zip code and the address in address input areas. The user 1 also input the family name and the given names of his/her family members to be printed on the postcards P in name input areas. The user 1 then inputs any information to be printed on the postcards P, such as the phone number, the fax number, the cellular phone number, and an E-mail address in contact number input areas. The user 1 then selects one of the telephone marks displayed in the telephone mark selection area. After inputting all the sender information, the user 1 clicks a “Next” button 47. The order reception server 21 stores the sender information in the database 23 when the user 1 clicks the “Next” button 47 in the sender information input Web screen 34. Whenever the user 1 uses this network photograph service thereafter, the sender information stored at this time is displayed.

The order reception server 21 displays another screen when the user 1 clicks the “Next” button 47 in the sender information input Web screen 34. In the case where the user 1 has already selected one of the template data sets T, a finish confirmation Web screen 38 is displayed. In the case where template selection has not been carried out, a template selection (step 1) Web screen 35 is displayed (Step S18).

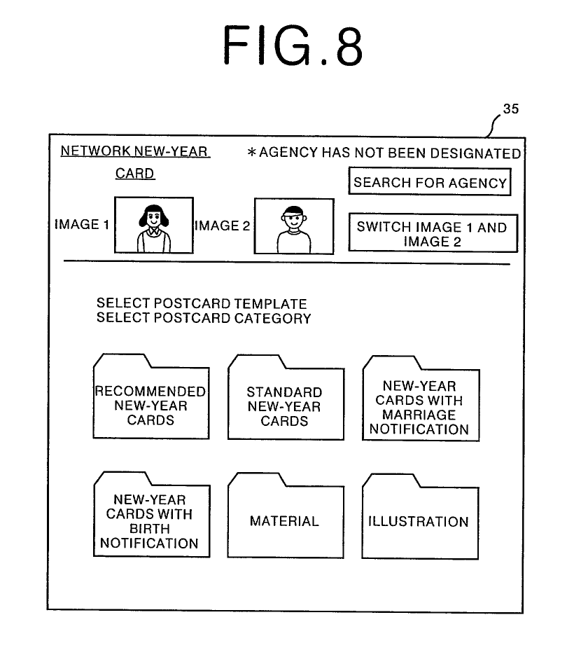

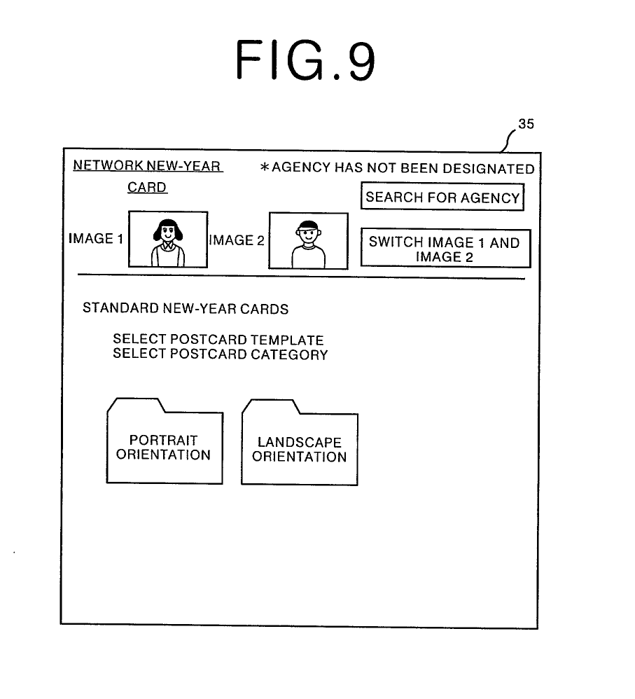

In this embodiment, template selection has not been carried out, since “2 pictures” has been selected in the network new-year card Web screen 31. Therefore, the template selection (step 1) Web screen 35 shown in FIG. 8 is displayed (Step S19). Categories of the template data sets T each having two image data insertion areas are displayed in the template selection (step 1) Web screen 35. The user 1 selects one of the categories as desired and clicks the desired category with the mouse. The order reception server 21 displays a template selection (step 2) Web screen 36 as shown in FIG. 9, after selection of the category by the user 1 in the Web screen 35. In the template selection (step 2) Web screen 36, the order reception server 21 enables the user 1 to select either the portrait orientation or the landscape orientation. In this embodiment, the user 1 is assumed to have selected “standard new-year cards” and the “portrait orientation”.

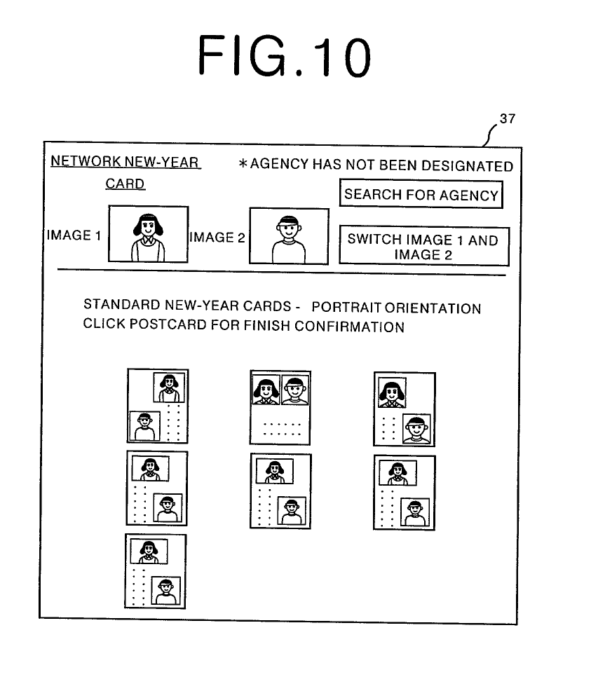

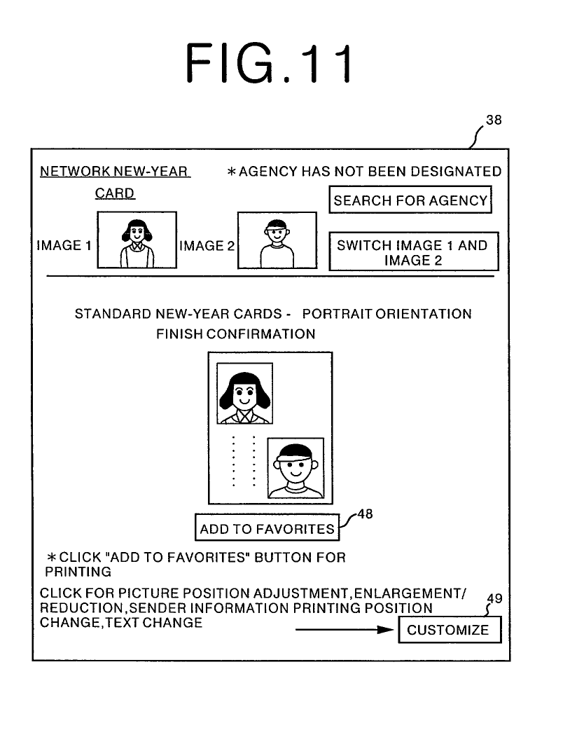

The order reception server 21 displays a template selection (step 3) Web screen 37 as shown in FIG. 10, after selection of the postcard orientation in the template selection (step 2) Web screen 36. In this screen are shown composite images of picture postcards generated by inserting the image data sets G1 and G2 in the image data insertion areas of each of the template data sets T corresponding to the conditions specified by the user 1.

Each of the template data sets T for “1 picture” has one image data insertion area for the image data set G1 in the portrait orientation or in the landscape orientation. Likewise, each of the template data sets T for “2 pictures” has the two image data insertion areas for the image data sets G1 and G2 in the portrait orientation or in the landscape orientation.

When the template data sets Tare displayed in the template selection (step 3) Web screen 37, the print images are shown by inserting the trimmed images in the portrait orientation or in the landscape orientation in the image data insertion areas for the image data sets G1 and G2 according to the orientations and the centers set in the image1 orientation/center setting Web screen and the image 2 orientation/center setting Web screen.

In this embodiment, since the user 1 has selected the “standard new-year cards” and the “portrait orientation” for “2 pictures”, the print images are generated and displayed by inserting the trimmed images in the image insertion areas of each of the template data sets T corresponding to the above conditions set by the user 1.

The user 1 selects any one of the template data sets T as desired by clicking the desired template data set with the mouse. The order reception server 21 displays the finish confirmation Web screen 38 shown in FIG. 11 (Step S20) after selection of the template data set made by the user 1 in the template selection (step 3) Web screen 37. The template data set T selected by the user 1 in the template selection (step 3) Web screen 37 is shown in the finish confirmation Web screen 38. The user 1 confirms the finish of the picture postcard and clicks an “Add to Favorites” button 48 if the composition result is satisfactory. In the case where the user 1 wishes to change a position or the enlargement ratio of the trimmed images, the user 1 clicks a “Customize” button 49. In this embodiment, the user 1 is assumed to have clicked the “Customize” button 49 for applying some changes to the picture postcard.

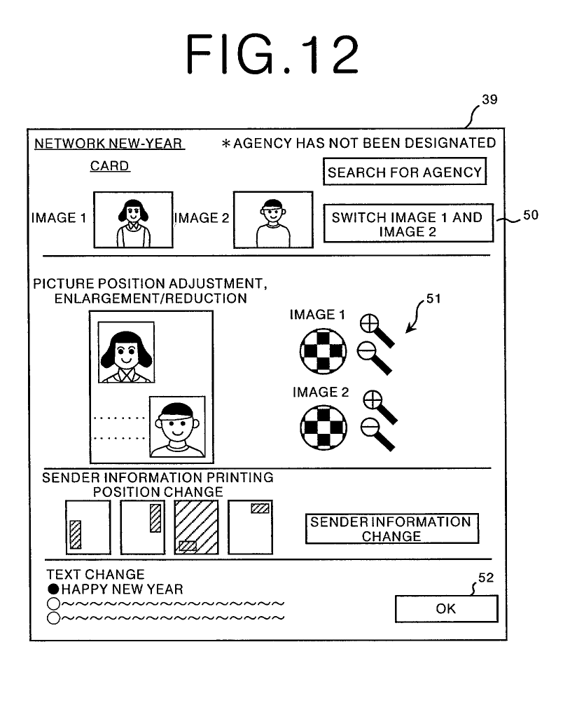

The order reception server 21 displays the customization Web screen 39 shown in FIG. 12 (Step S21) when the user 1 clicks the “Customize” button 49 in the finish confirmation Web screen 38. In the case where a “Switch image 1 and image 2” button 50 is clicked in the customization Web screen 39, the trimmed image represented by the image data set GI in one of the image data insertion areas of the template data set is replaced with the trimmed image represented by the image data set G2 in the other image data insertion area and vise versa. An “Image Manipulation” icon 51 in the customization Web screen 39 enables the user to change the position and the enlargement ratio of the trimmed images represented by the image data sets G1 and G2. Furthermore, a position of inserting the sender information and a color thereof, and the text to be printed on the picture postcard can also be changed in the customization Web screen 39. The user 1 clicks an “OK” button 52 once the customization is finished.

The order reception server 21 displays the finish confirmation Web screen 38 again when the user 1 clicks the “OK” button 52 in the customization Web screen 39. The user 1 clicks the “Add to Favorites” button 48 if a result of the finish of the picture postcard is satisfactory in the finish confirmation Web screen 38.

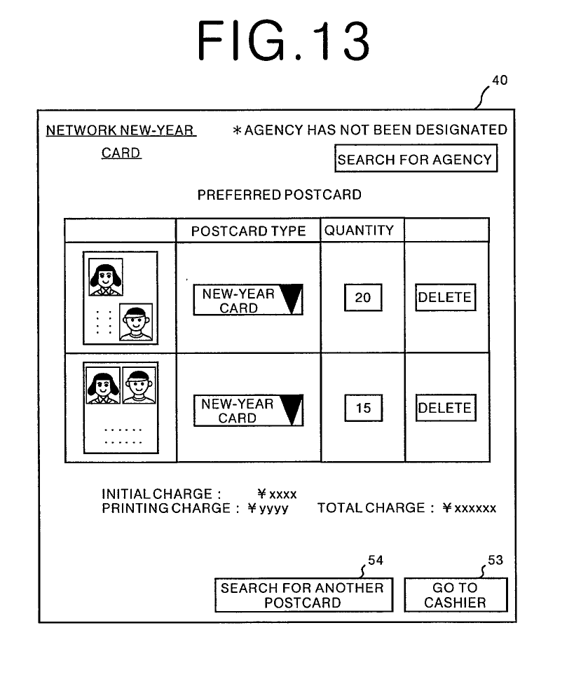

The order reception server 21 stores the postcard data set PD in the database 23 when the user 1 clicks the “Add to Favorites” button 48 in the finish confirmation Web screen 38. The order reception server 21 then displays a favorites Web screen 40 shown in FIG. 13 (Step S22). In this screen, the postcard data set PD added this time id displayed, together with all postcard data sets registered in the past in the case where the user 1 has registered the postcard data sets. The user 1 can input the quantity for each of the postcard data sets displayed in the favorites Web screen 40. The order reception server 21 calculates a charge therefor and displays an initial charge, a printing charge, and a total charge. The user 1 confirms the content of the print order and the charges, and clicks a “Go to Cashier” button 53 if the user agrees. In the case where the user 1 wishes to generate another postcard data set PD′, the user 1 clicks a “Search for Another Postcard” button 54 (Step S23).

The order reception server 21 displays the template selection (step 1) Web screen 35 when the user 1 clicks the “Search for Another Postcard” button 54 in the favorites Web screen 40. The procedure from Step S19 to Step S22 is then repeated to enable the user 1 to generate and register the postcard data set PD′.

In this embodiment, the user 1 is assumed to have clicked the “Go to Cashier” button 53, without adding the postcard data set PD′.

The order reception server 21 displays another screen when the user 1 clicks the “Go to Cashier” button 53 in the favorites Web screen 40. In the case where the user 1 has designated the agency, an order confirmation Web screen (not shown) is displayed. In the case where agency designation has not been carried out, an agency designation Web screen (not shown) is displayed (Step S24). In this embodiment, the user 1 is assumed not to have designated the agency.

The order reception server 21 displays the agency designation Web screen (Step S25) when the user 1 clicks the “Go to Cashier” button 53 in the favorites Web screen 40. Candidates for the agency are displayed in this screen, and the user 1 can select one of the candidates. The candidates may be displayed according to any method. For example, the user 1 selects a prefecture and then a city or a town in the selected prefecture. Stores in the selected city or town are then displayed as the candidates. Alternatively, stores close to the address input by the user 1 in the sender information input Web screen 34 may be displayed as the candidates. The user 1 selects the agency and clicks a “Next” button in this screen.

The order reception server 21 displays the order confirmation Web screen (Step S26) when the user clicks the “Next” button in the agency designation Web screen. In the order confirmation Web screen is displayed the content of the print order, such as the postcard data set PD generated by the user 1 and the quantity therefor, and the name and the address of the agency. The user 1 confirms the content of the print order in the order confirmation Web screen, and clicks an “Order Confirmed” button. The content of the print order is then sent as order information to the order reception server 21.

The order reception server 21 in the print order reception center 2 receives the order information (Step S2 in FIG. 2), and generates the postcards P by printing the postcard data sets PD according to the order information (Step S3). The label KP on which the address information K of the agency designated by the user 1 is printed is also generated (Step S4). The label KP is pasted on the bag containing the postcards P and delivered to the agency address (Step S5). The DPE store 3 receives the postcards P (Step S6). The user 1 visits the DPE store 3 and receives the postcards P after paying the total charge (Step S7) to end the operation.

As has been described above, in this embodiment, the composite images generated from the image data G uploaded by the user 1 and the template data sets T are displayed at the time the user 1 selects one of the template data sets. In this manner, the user 1 can easily select the desired template data set.

In this embodiment, the user 1 may register the sender information for a plurality of persons. Furthermore, different sender information may be printed for the respective postcard data sets that have been registered.

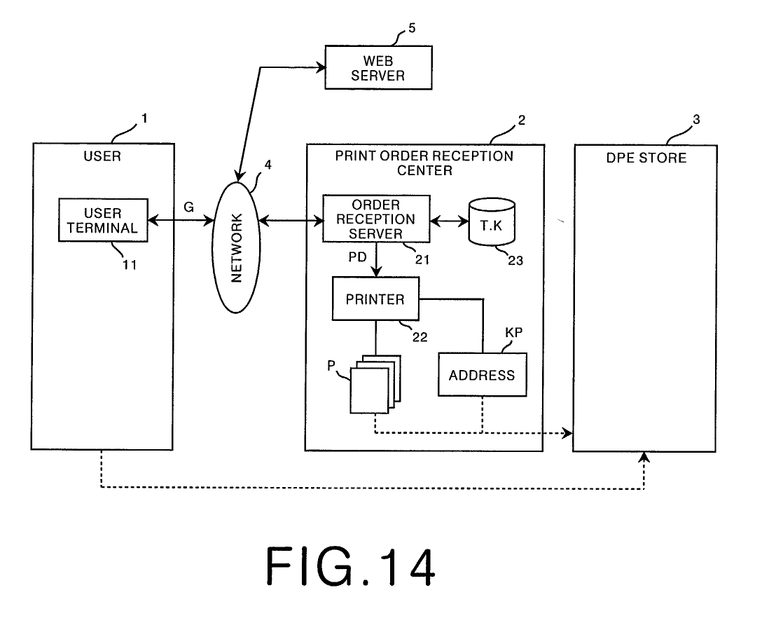

A second embodiment of the present invention will be explained next. FIG. 14 is a block diagram showing a configuration of a network photograph service system adopting a print order system of the second embodiment of the present invention. In the second embodiment, the same elements as in the first embodiment have the same reference numbers and detailed explanation thereof is omitted.

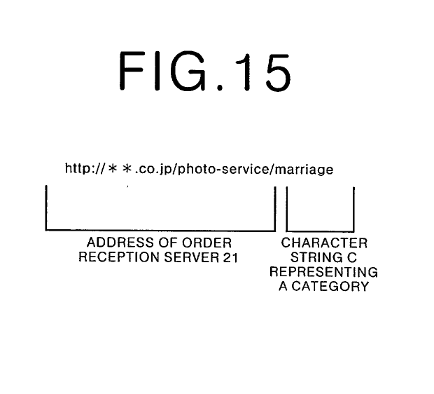

In the second embodiment, a user 1 connects to a Web server 5 connected to a network 4, and views a Web screen displayed by the Web server 5. By a link in the Web screen, the user 1 can be connected to an order reception server 21. A character string or a link icon for the link to the order reception server 21 shown in the Web screen displayed by the Web server 5 has the address of the order reception server 21 added with a character string C representing a category defined by the order reception server 21, as shown by an address in FIG. 15.

In this embodiment, the character string C is added to the end of the order reception server address. However, the character string C may be added to any portion of the address. The Web server 5 in this embodiment will be described as a Web server providing information on marriage. Therefore, the character string C is assumed to be “marriage” representing the category of marriage. However, any category defined by the order reception server 21 may be used.

The user 1 views the information on marriage provided by the Web server 5. In order to generate postcards for announcement of marriage, the user 1 clicks the link icon in the Web screen displayed by the Web server 5 to connect to the order reception server 21.

The order reception server 21 assumes that the category represented by the character string C added by the Web server 5 has been selected at the time a template selection (step 1) Web screen is displayed as in Step S19 in FIG. 3. Since “marriage” has been added as the character string C in this embodiment, the order reception server 21 assumes that the user 1 has selected the category of marriage, and then displays a template selection (step 2) Web screen for enabling the user 1 to select either the portrait orientation or the landscape orientation.

In the second embodiment, template data sets of the category interested by the user 1 can be displayed promptly based on the category represented by the character string C added by the Web server 5 to which the user 1 was connected immediately before the connection to the order reception server 21.

What is claimed is:

1. A print order method used in a printing service for printing a picture postcard by generating a composite image according to specification input by a user from image data owned by the user and a template data set selected by the user from a plurality of postcard template data sets prepared in advance, the print order method comprising the steps of:
displaying a plurality of print images generated by composition of the image data with the respective postcard template data sets; and
enabling the user to select the template data set by confirming how the composite image looks by using the displayed print images.

2. A print order system comprising:
an order reception server for receiving a print order for a picture postcard generated by composition of image data owned by a user with a template data set selected by the user from a plurality of postcard template data sets prepared in advance; and
a user terminal connected to the order reception server via a network and used by the user for placing the print order, wherein
the order reception server has a program installed therein to cause the order reception server to execute the procedures of;
displaying on the user terminal a plurality of print images generated by composition of the image data with the respective postcard template data sets; and
enabling the user to select the template data set based on the displayed print images.

3. A print order system as defined in claim 2, wherein the order reception server carries out the composition of the image data with the template data set, based on composition information input by the user for defining an area of an image represented by the image data to be inserted in an image data insertion area of the template data set.

4. A print order system as defined in claim 2 or 3, wherein the order reception server further carries out composition of personal information of the user such as the name and the address input by the user with the template data set.

5. A print order system as defined in claim 2, wherein the order reception server stores personal information input by the user and uses the personal information for composition with the template data set.

6. A print order system as defined in claim 2, wherein the order reception server stores the content of the print order for the picture postcard placed by the user and enables reprinting of the picture postcard based on the stored content of the print order.

7. A print order system as defined in claim 2, wherein the order reception server receives a narrowing condition for narrowing the postcard template data sets from an external Web server connected thereto via the network and displays only the postcard template data sets agreeing with the narrowing condition among the postcard template data sets in order to enable the user to select the template data set used for generation of the picture postcard.

8. A program that causes a computer to execute a print order method used in a printing service for printing according to specification input by a user of a picture postcard through composition of image data owned by the user with template data sets prepared in advance, the program comprises the procedures of:
receiving a print order; and
displaying a plurality of print images generated by the composition of the image data with the template data sets.
